(19) United States
(12) Patent Application Publication
(10) Pub. No.: US 2006/0073441 A1
(43) Pub. Date: Apr. 6, 2006

(54) Calendar and method for weight loss

(76) Inventor: A. Casey Kwan-Hou, Henderson, NV (US)

Correspondence Address: LETZ KWAN, 2263 VANDALIA AVENUE, LOS ANGELES, CA, 90032, US

(21) Appl. No.: 10/945,326

(22) Filed: Sep. 19, 2004

(51) Int. Cl. G09B 19/00

(52) U.S. Cl. 434/127

(57) ABSTRACT

A new weight loss method that includes: (1) A monthly flip calendar; (2) Healthy, fit models with a place to put user's face into the picture to help visualize the results; (3) Each day has a set menu which will provide about 1200 calories for the women calendar and 1500 calories for the men; (4) Magnetic strip in the back to attach to refrigerator; (5) Quarterly measurements of problem areas of arms, thighs, calves, chest, hips, waist, and neck; (6) monthly stickers that state “one fast food meal”, “special occasion—meal unrestricted”, and “Happy Birthday!!—Unrestricted meal”; (7) “F” will be marked on special days to indicate unrestricted or “free” meals, “W” will signify the weighing days, and E for “exercise”; (8) A “contract” to be signed by participant user to improve compliance to program; (9) Provide PDA download-able version for people who are frequently away from home.

### BACKGROUND OF THE INVENTION

1. Field of the Invention

The present invention generally relates to the field of weight loss and more specifically to a calendar and method for weight loss.

2. Brief Description of the Related Art

Obesity is the most prevalent nutritional disorder in the United States. According to the National Center of Health Statistics (2000&2001), the number of obese children and adults has been increasing. It is suggested that genetics and environmental factors both play a role. Although genetic factors contribute towards the predisposition of obesity, the current environment of increased food intake and decreased energy expenditure is also a large contributing factor (Hill, J. O. & Peters, J. C., 1998). Some factors attributable for the increased energy intake are advertisements for low priced and high-energy dense foods, marketing of larger portion sizes, increased frequency of restaurant meals, and use of more fast-foods (French, S. A., Story, M., & Jeffery, R. W., 2001). Some factors associated with decreased energy expenditure are labor saving devices (such as remote controls); working at a job that is sedentary; decreased physical activity related to watching television, playing videogames, and using the computer (Dowda, M., Ainsworth, B. E., Addy, C. L., Saunders, R., & Riner, W., 2001; Crespo, C. J. et al., 2001; Dietz, W. H, 2001). Prevention of obesity is frequently attempted through educational approaches aimed at improving knowledge and motivation, with consequent presumed impact on individual lifestyle choices (Kumanyika, S. K. 2001).

Small changes may have a large impact on weight management, which in turn, can lead to the resolution or prevention of further progression of heart disease, diabetes, and the stigma of obesity. An effective weight management tool should be geared towards behavior change in exercise and eating habits. Successful weight loss requires motivation and guidelines that help busy people make quick, appropriate, every-day decisions.

Many people seek merchandise or publications to motivate weight loss and provide concrete guidelines on foods to eat. However, these products have been rare or too complicated for daily use. In the past, motivational tools have usually been ineffective because they are usually not individualized.

The calendar and method for weight loss of the present invention is a personalized motivational weight loss tool which provides modeling of the results that can be gained by adhering to the meal and exercise recommendations set by the program. Incorporated into the present invention are menus outlining to users of the present invention exactly what and how much to eat, without mandatory computer entries (Participants may choose to enter information into personal databases for the sake of tracking progress or for customizing diet, but this is not mandatory for success while using the calendar and weight loss method). Menus would be very helpful for people who want to be healthy eaters, but who cannot decipher the fad diet from the healthy diet. This would also minimize the complaint of food choices being too abundant and public knowledge of nutrition being too incomplete or confused by marketing. For these reasons the present invention is a weight loss system which includes: (1) a daily visual motivational tool provided in a form of a model body but with the participants face; (2) a daily menu plan; (3) allowance to liberalize/customize meals when downloaded to a personal organizer system such as a PDA (personal daily assistant); (4) weights weekly; (5) exercise reminders almost every other day; (6) quarterly tape measures of problem body areas; (7) “special occasion-no restriction meal” stickers for birthdays, holidays, and parties; and (8) A contract to improve compliance to exercise and menu recommendations.

### SUMMARY OF THE INVENTION

The Calendar and Method for Weight Loss (Super-Model Diet), weight loss program of the present invention is a motivational tool that serves the needs of users who need something that serves as a daily reminder of what a person is working so hard to accomplish. This program will provide a calendar that features monthly models of healthy, fit, attractive males or females for the men or women respectively who need inspiration for weight loss. The male user will have a calendar specific for him with male models and the women will have a calendar specific for her with female model figures. Users will choose their specific calendar based on their own gender, body type and preference.

The calendar and weight loss method of the present invention is unlike other calendars because it allows the user to place his or her picture in the place of the model's face. Such is accomplished as there will be a cut out area where the model's face would have been, and is excluded. The user is instructed to place a picture of his/her face in the hole. As time progresses, about every month, the user's face will model a different healthy body according to the desired ideal body by each user. This will serve as a great motivational tool because the user gets to see the body he/she is working towards. Users of the present invention will picture this monthly model, not of a stranger, but of themselves.

The variety of monthly models will allow for continued interest in the calendar and renewing encouragement if users happen to “fall off” the meal plans.

The Calendar and Method for Weight Loss of the Present invention utilizes an attachment means, by way of example and not limitation, such as a magnetic strip on the reverse or back side so as to be placed to a refrigerator or other location frequented by users of the present invention, serving as a reminder to avoid overeating.

Each day of the Calendar, of the present invention, will be imprinted with a recommended breakfast, lunch, and dinner menu. A brief statement will present this concept on the first page of the Calendar of the present invention. The statement will encourage compliance to menus daily but allow for substitution between different days of the week to meet food preferences and minimize boredom. A way of example and not limitation is: “January 10: breakfast—1 cup oatmeal+½ cup Nonfat milk+2 eggs”; “January 11: breakfast—1 cup light yogurt+3 slices lean turkey+1 tortilla”. If the user wants to eat for example “1 cup light yogurt+3 slices lean turkey+1 tortilla” for breakfast on January 10th, or a day ahead of schedule, this would be an allowed substitution.

The calendar will aim a user towards 1200 calories for women and 1500 calories for men as a daily intake. This numerical value is based on the recommendation that adults maintain a minimum of 1200 calories a day and is based on a weight loss restriction of 20 calories per kg of ideal body weight for average height women and men.

However, respecting that everyone is not at average height and weight, the Calendar and Method for Weight Loss allows for increase or decrease in calories on weekends. Friday, Saturday, and Sunday will be marked with the symbol “F” to signify that one free or unrestricted meal is allowed that day. This is because most people fall off their “regular” diet plans around the weekends, as many “dieters” stop eating healthy after straying from their other diet “plan” just once. The allowance as prescribed in the present invention to eat favorite foods for the weekend will encourage long-term maintenance on the plan.

Long-term weight loss maintenance has been accomplished by only a small fraction of the dieting population. According to a survey by the National Weight Control Registry, weekly weighing helped people keep the weight off long term. For this reason, the Calendar and Method for Weight Loss of the present invention requires a weekly weighing on Thursday. Thursday is the ideal day of the week because the participant will be allowed to eat freely for I meal/day in the following 3 days. They will need the extra motivation to continue eating well; even when not restricted. The symbol “W” will signify the days for which weighing is required as imprinted on the Calendar.

Exercise would be required every Monday, Wednesday, and Friday. A reminder would be printed on the calendar with the symbol “E” for “exercise”. A recommendation of 20-45 minutes three times a week will be given because weight loss and building of lean muscle to increase energy expenditure, according to the present invention, requires exercise. The first page will provide an explanation key of the symbol and the corresponding activity.

The Calendar and Method for Weight Loss of the present invention involves assessing dieting success by measuring the circumference of the body's “problem areas” to determine fat loss, as still another way of measuring success is in “actual fat loss” or (AFL). The first page of the calendar will explain the need to measure the thighs, arms, waist, chest, hips, calves, and neck to assess changes related to compliance to meal/exercise plans. This will help motivate people and offset the minds of users who may gain weight due to muscle but have actually lost fat. Muscle weighs more than fat and it is possible to gain weight and still be losing fat on any exercise program. Many people are discouraged by weight gain, as they do not understand that they may still be getting healthier, fitter, and more attractive if it is due to increased muscle mass and a reduction in fat measured by AFL.

Birthdays, holidays, and parties usually provide an over abundance of temptations that would cause even some of the best “self dieters” who are not on any prescribed weight loss plan, to lose control. For this reason, the Calendar and Method for Weight Loss of the present invention minimizes a user from a feeling of failure—which could ultimately lead to the abandonment of the weight loss effort—by providing a special allowance for these special days. This way, users of the present invention also feel that they can eat some of their favorite, unhealthy foods once in a while. Such allowances are for birthdays and fast food cravings as designated by providing monthly stickers as by way of example and not limitation: (1) “Happy Birthday!! Unrestricted meal”; (2) “one fast food meal”; or (3) “special occasion, meal unrestricted”.

Every Friday, Saturday, and Sunday would allow for one “free meal” each day because many users may wish to eat out or have guests on these days. These days would be marked on the calendar with the symbol “F” for “free”.

The present invention combines the advantages of having a weight loss method and a calendar for daily review, whereby a simple to follow and effective method for weight loss will be provided.

This invention consists of a calendar for insertion of the user's own picture serving as a means for motivation and a diet regimen with simple to follow guidelines and allowances for effective weight loss. Other objects and advantages of the present invention will become apparent from the following descriptions, taken in connection with the accompanying drawings, wherein, by way of illustration and example, an embodiment of the present invention is disclosed.

In comparison to the existing technologies, the uniqueness of this invention is set forth as the following:

In accordance with a preferred embodiment of the invention, there is disclosed a Calendar and Method for Weight Loss: (1) a calendar and attachment means for securely attaching a user's picture as a daily visual motivational tool provided in a form of a model body but with the participants face; (2) a daily menu plan; (3) allowance to liberalize/customize meals when downloaded to a personal organizer system such as a PDA (personal daily assistant); (4) weekly weighing; (5) exercise reminders almost every other day; (6) quarterly tape measures of problem body areas; (7) “special occasion-no restriction on meal” stickers for birthdays, holidays, and parties; and (8) a contract to improve compliance to exercise and menu recommendations.

Still other objects, features, and attendant advantages of the present invention will become apparent to those skilled in the art from a reading of the following detailed description of embodiments constructed in accordance therewith, taken in conjunction with the accompanying drawings.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

The invention of the present application will now be described in more detail with reference to preferred embodiments of the apparatus and method, given only by way of example, and with reference to the accompanying drawings, in which:

FIG. 1 shows an exemplary view of the present invention with male model.

FIG. 2 shows an exemplary view of the present invention with a female model.

FIG. 3 illustrates a flowchart useful in describing an exemplary method for weight loss using the Calendar and method of the present invention.

### DESCRIPTION OF PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner. Referring to the drawing figures, like reference numerals designate identical or corresponding elements throughout the several figures.

In accordance with a preferred embodiment of the invention, there is disclosed a calendar and method for weight loss of the present invention that is a personalized motivational weight loss tool which provides modeling of the results that can be gained by adhering to the meal and exercise recommendations set by the program. Incorporated into the present invention are menus outlining to users of the present invention exactly what and how much to eat, without mandatory computer entries (Participants may choose to enter information into personal databases for the sake of tracking progress or for customizing diet, but this is not mandatory for success while using the calendar and weight loss method). Menus would be very helpful for people who want to be healthy eaters, but who cannot decipher the fad diet from the healthy diet. This would also minimize the complaint of food choices being too abundant and public knowledge of nutrition being too incomplete or confused by marketing. For these reasons the present invention is a weight loss system which includes: (1) a daily visual motivational tool provided in a form of a model body but with the participants face; (2) a daily menu plan with breakfast, lunch and dinner; (3) allowance to liberalize/customize meals when downloaded to a personal organizer system such as a PDA (personal daily assistant); (4) weights weekly; (5) exercise reminders almost every other day; (6) quarterly tape measures of problem body areas; (7) “special occasion-no restriction on meal” stickers for birthdays, holidays, and parties; and (8) A contract to improve compliance to exercise and menu recommendations.

In comparison to the existing technologies, the uniqueness of this invention is set forth as the following:

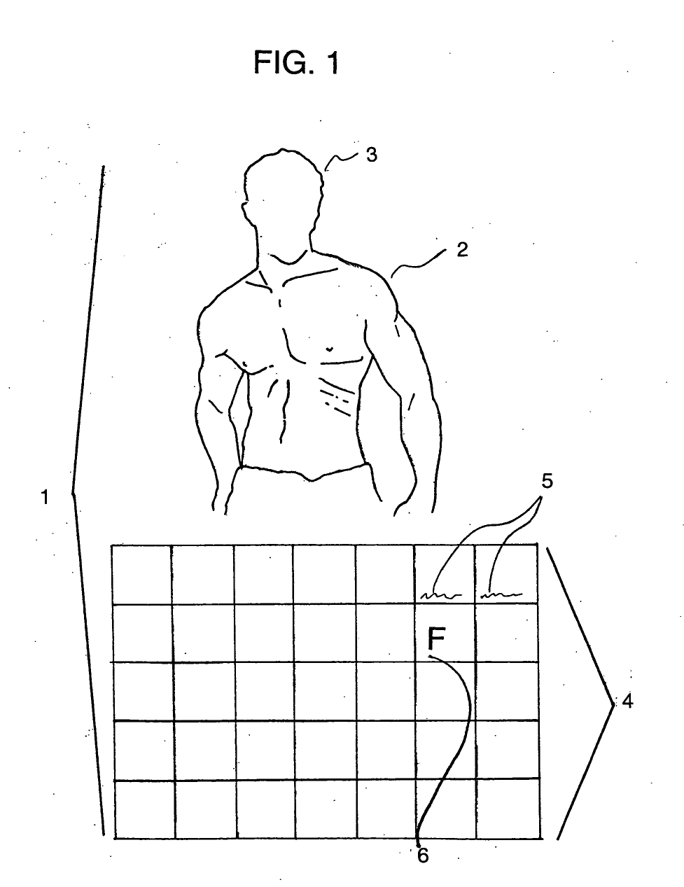

FIG. 1 shows an exemplary view of the present invention (1) with a male model showing a male specimen ideal body (2) serving as a motivational tool and a removed face (3) for insertion of a user's face. Dates (4) are detailed with daily menus (5) and have weekly reminders for weighing on Thursdays. Dates (4) also have exercise reminders on Mondays, Wednesdays and Fridays. Dates (4) will have a quarterly reminder to take tape measures of problem areas.

With reference to Daily Menus (5), the menu can be replaced by covering with stickers (6) or other symbols signifying “free day” with an “F” and usually on a Friday, Saturday or Sunday.

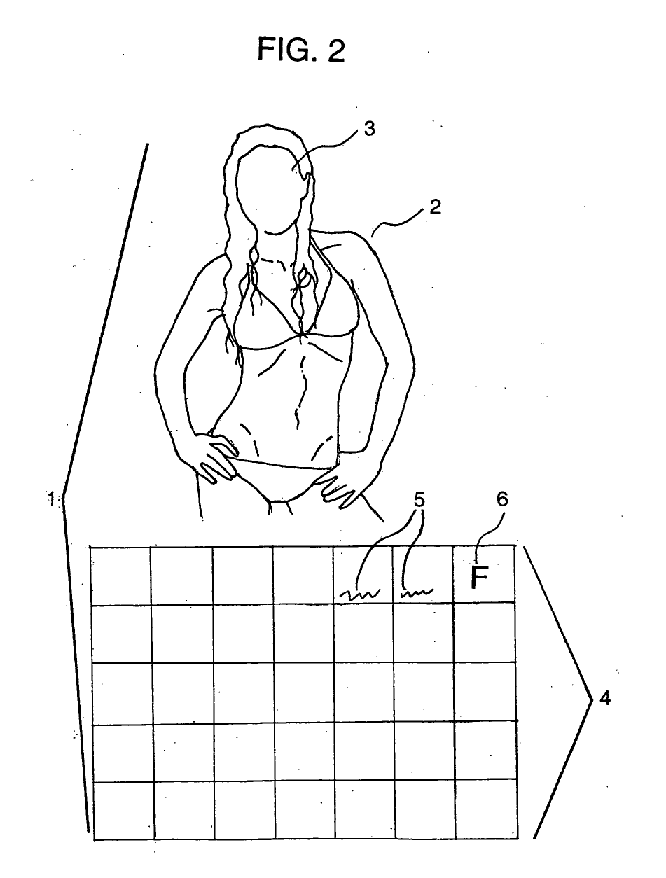

FIG. 2 shows an exemplary view of the present invention (1) with female model showing a female specimen ideal body (2) serving as a motivational tool and a removed face (3) for insertion of a user's face. Dates (4) are detailed with daily menus (5) and have weekly reminders for weighing on Thursdays. Dates (4) also have exercise reminders on Mondays, Wednesdays and Fridays. Dates (4) will have a quarterly reminder to take tape measures of problem areas.

With reference to Daily Menus (5), the menu can be replaced by covering with stickers (6) or other symbols signifying “free day” with an “F” and usually on a Friday, Saturday or Sunday.

With reference to FIG. I and FIG. 2, stickers (6) may be placed on certain dates with a limited number of “Happy Birthday!! Unrestricted meal” (as a birthday cake); or “one fast food meal” (as a hamburger, French fries, and soda); “special occasion, meal unrestricted” or “free day” as denoted by an “F” as shown on FIG. 1 as an example and not limitation.

Other special occasion stickers may be placed by the user as lifestyles of users may differ. These stickers (6) denoting “special” or “unrestricted” meals will be limited in number, so as not to allow the user to fall off the diet regimen after the “special” or “unrestricted” meal period is over.

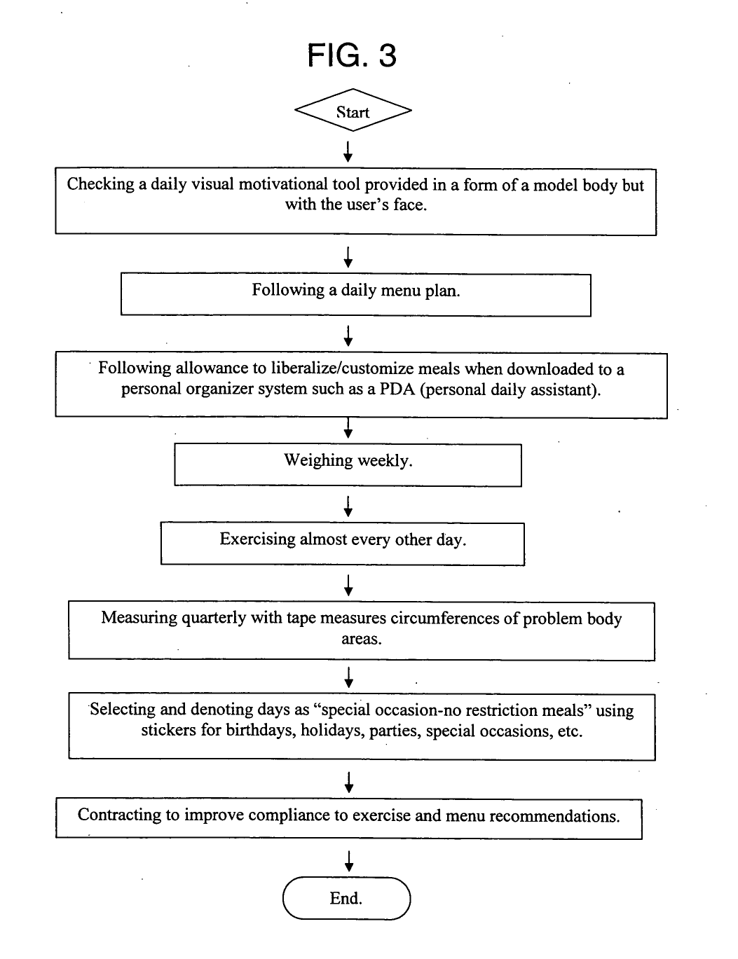

FIG. 3 illustrates a flowchart useful in describing an exemplary method for weight loss using the Calendar and method of the present invention. FIG. 3 outlines a method of weight loss comprising the steps of:

(a) checking a daily visual motivational tool provided in a form of a model body but with the user's face;

(b) following a daily menu plan;

(c) following allowance to liberalize/customize meals when downloaded to a personal organizer system such as a PDA (personal daily assistant);

(d) weighing weekly;

(e) exercising almost every other day;

(f) measuring quarterly with tape measures circumferences of problem body areas;

(g) selecting and denoting days as “special occasion-no restriction meals” using stickers for birthdays, holidays, parties, special occasions, etc; and

(h) contracting to improve compliance to exercise and menu recommendations.

Still other objects, features, and attendant advantages of the present invention will become apparent to those skilled in the art from a reading of the following detailed description of embodiments constructed in accordance therewith, taken in conjunction with the accompanying drawings.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention described by the foregoing includes all changes that come within the meaning, range and equivalence thereof and is intended to be embraced therein.

What is claimed is:

1. A Calendar and Method for Weight Loss comprising:
a calendar with dates corresponding to the year, month, week, day and date;
wherein, each month has a different picture of a model's entire body;
wherein each model's face is removed;
wherein each missing model's face has a place for insertion of a picture of a user's face, thereby forming a visual of said model's body and figure with said user's face;
wherein specific days as selected by said user can be designated by symbols corresponding to events;
wherein, said calendar has attachment means;
wherein said calendar provides a daily food routine and daily menu plan;
wherein, said calendar proscribes for “Free Days”;
wherein said calendar proscribes weighing days;
wherein said calendar proscribes exercise days;
wherein said calendar proscribes measuring Actual Fat Loss (AFL);
wherein said calendar utilizes a personal contract to promote and improve compliance to exercise and menu recommendations;
whereby a simple to follow and effective method for weight loss will be provided.

2. The invention according to claim 1, wherein said visual of said model's body and figure with said user's face serves as a motivational tool.

3. The invention according to claim 1, wherein said model is male or female corresponding to said user's profile and body type.

4. The invention according to claim 1, wherein said symbol is a birthday cake designating birthday, or other symbol designating annual events.

5. The invention according to claim 1, wherein said attachment means is a magnet for attachment to metal such as a refrigerator.

6. The invention according to claim 1, wherein said attachment means is Velcro or adhesives.

7. The invention according to claim 1, wherein said daily food routine and said daily menu plan is customizable for personal preference within guidelines of said calendar and downloadable to a personal scheduling means.

8. The invention according to claim 1, wherein said “Free Days” are denoted by a symbol “F”.

9. The invention according to claim 8, wherein said days denoted by an “F” represent special occasions and no restriction meals.

10. The invention according to claim 1, wherein said weighing days are each Thursday.

11. The invention according to claim 1, wherein said exercise days are each Monday, Wednesday and Friday.

12. The invention according to claim 1, wherein said Actual Fat Loss (AFL) is measured quarterly, and is denoted by reminders on said calendar.

13. The invention according to claim 12, wherein AFL is measured on thighs, arms, waist, chest, hips, calves, and neck, other problem areas, etc.

14. The invention according to claim 1, wherein said specific days as selected by said user and as designated by symbols corresponding to events, such as birthdays, said annual events, said “Free Days”, parties or other special events, denote an unrestricted meal.

15. The invention according to claim 14, wherein said unrestricted meal is a “Fast Food Combo”.

16. The invention according to claim 14, wherein said specific days are denoted by symbols affixed to said calendar as a sticker.

17. A method for weight loss, comprising the steps of:
(a) checking a daily visual motivational tool provided in a form of a model body but with the user's face;
(b) following a daily menu plan;
(c) following allowance to liberalize/customize meals downloadable to a personal organizer system such as a PDA (personal daily assistant);
(d) weighing weekly;
(e) exercising almost every other day;
(f) measuring quarterly with tape measures circumferences of problem body areas;
(g) selecting and denoting days as “special occasion-no restriction meals” using stickers for birthdays, holidays, parties, special occasions, etc; and
(h) contracting to improve compliance to exercise and menu recommendations.
